(19) United States
(12) Patent Application Publication
(10) Pub. No.: US 2006/0262696 A1
(43) Pub. Date: Nov. 23, 2006

(54) Method and device for recording information on a multilayer information carrier

(76) Inventor: Pierre Hermanus Woerlee, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/568,834

(22) PCT Filed: Aug. 20, 2004
(86) PCT No.: PCT/IB04/51508

§ 371 Date: Feb. 17, 2006

(30) Foreign Application Priority Data
Aug. 20, 2003 (EP) 03103207.1

(51) Int. Cl. G11B 7/20

(52) U.S. Cl. 369/94

(57) ABSTRACT

The invention discloses a method and a device for recording information on a multi layer optical disc using a multi session format. The use of multi sessions allows for an efficient use of the storage capacity of the disc, and for a fast finalization time.

The invention relates to a method and a device for recording information on a multi layer information carrier. In particular, the invention relates to a method and a device for recording information on a dual layer DVD+R or DVD+R/W disc, such that it becomes compliant with the dual layer DVD-ROM standard.

DVD-ROM is successful in both the Personal Computer (PC) world and the Consumer Electronics (CE) world. For film and content distribution dual layer DVD-ROM is frequently used. Recently, recordable (R) and rewritable (R/W) single layer DVD formats were introduced. However, their storage capacity is currently limited to 4.7 GB. More storage capacity is needed for both CE and PC applications. Dual layer DVD+R offers such a capacity increase. It is a dual-layer write-once disc with 8.5 GB of storage capacity. The dual layer DVD+R format should preferably be compatible with the DVD-ROM dual layer format as well as with the single layer DVD+R format. This is important for compatibility with existing DVD-ROM players and PC drives.

Information is stored on these optical record carriers according to specific rules and layouts, generally referred to as formats, which are described in documents generally referred to as a standards.

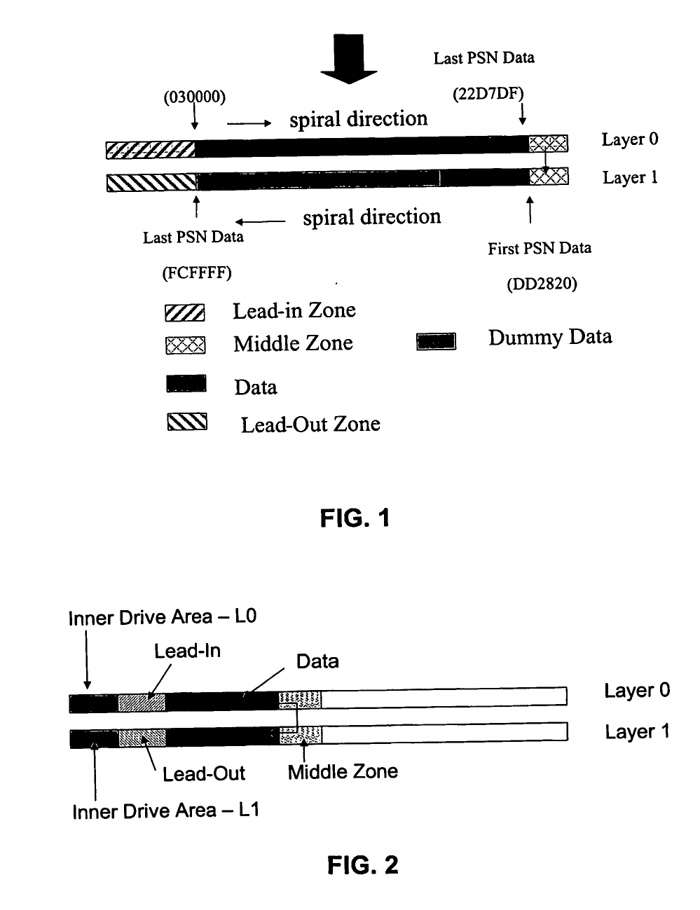

For dual layer DVD-ROM there are two track modes defined in the DVD-ROM standard (Standard ECMA—267, 120 mm DVD—Read-only disc); Opposite Track Path, OTP, and Parallel Track Path, PTP. For dual layer DVD discs the OTP track mode (as schematically shown in FIG. 1) is preferred because of a reduced layer-jump time during playback.

It should be notes that the dual layer DVD-ROM standard requires dummy data to be present after the user data up to the lead-out zone at the end of the disc. When such dummy data is not present, the drive may crash. Hence a long finalization time (for recording the dummy data) and a large loss of storage space have to be accepted for DVD-ROM compatibility.

It is noted that a multi-session layout on multi layer discs is not known nor standardized yet

It is an object of the present invention to provide a method and device for recording a multi-session layout that exploits the multi layer structure of multi layer discs as well as offers compatibility with existing DVD standards. Preferably, such a method and device keep the finalization time a minimum.

According to the invention, a physical definition of a multi-session format for multi layer discs is presented. This multi-session layout offers a possibility for efficient information recording while maintaining compatibility with existing DVD standards (that is, eliminate unwritten spaces). According the invention a super session is introduced which includes one or more layer jumps.

For compatibility with DVD-ROM no empty, that is unwritten, zones are allowed on the layers of a recordable multi-session multi layer DVD discs. A dual layer DVD disc comprises two layers generally referred to as layer 0 (L0) and layer 1 (L1), where the L0 layer is the information layer located closest to the side of a disc where a radiation beam, such as a laser beam, used for reading and/or recording the information enters the disc. Now, for compatibility with DVD-ROM no empty zones are allowed on the L0 layer and the L1 layer of such a recordable dual layer DVD discs between the first PSN in the data zone of the L0 layer, the middle zones, and the last PSN in the data zone of the L1 layer near the disc end. Here, PSN is defined to be the number of a Physical Sector, that is, the number of a smallest addressable part of a track of a disc that can be accessed independently of other addressable parts.

FIG. 1 show a dual layer disc where the L0 layer is completely written but where there is only a small amount of data on the L1 layer. Therefore, there should be dummy data between end of the data on the L1 layer and its lead-out zone. In a worst-case situation (fully recorded L0 layer and only a very small amount of data on the L1 layer) this would mean that almost a full layer of dummy data has to be written. This may be time consuming (up to 30 minutes of recording time at a recording speed of 2.4×), and a lot of storage space is wasted. Furthermore, during a layer jump from layer 0 to layer 1 (respectively, from layer 1 to layer 0) there should always be some data on layer 1 (respectively, layer 0) to guarantee DVD-ROM compatibility.

According to the present invention a super session is defined which includes one or more layer jumps. The method according to the invention comprises at least on such super session.

According to an embodiment of the invention the physical address space on a disc is fixed. In a preferred embodiment the physical address space on a disc is fixed by positioning the middle zone at the maximum PSN on the L0 layer. Preferably the disc space and/or location of the middle zone should be written in the lead-in and lead-out zones, as well as in the ADIP information.

According to an embodiment of the invention empty spaces in a single super session are as small as possible. This implies a symmetrical distribution of data and files on both layers.

According to an embodiment of the invention the most recent session information (often referred to as file system info) is included when closing the session. Preferably this is done in such a way that it is compatible with existing DVD standards. According to an embodiment of the invention a jump zone (such as the middle zone) of a fixed amount of Error Correction Code (ECC) blocks containing dumpy data (for example all zero's) is written in order to avoid errors during read out.

According to an embodiment of the invention intro, closure and jump zone sectors have bit settings such that they are considered as data zone sectors (except for the lead-in and the lead-out of a first session).

Preferably, the recorded data is divided symmetrically over both layers in a dual layer discs is shown in FIG. 2, even in a single session and even when data has to be added later on. Reference is made to the co-pending European Patent Application EP03102608.1 (PHNL031034).

The advantages of this invention are flexibility, ease of use (for example, the first session will play in many DVD video players), reduced finalization time, efficient use of storage capacity, and compatibility with the various DVD standards (such as for example DVD-ROM and single layer DVD+R).

These and further aspects and advantages of the invention will be discussed hereinafter with reference to the accompanying figures, where

FIG. 1 is a schematic drawing of an OTP type DVD-ROM compatible disc with a single session,

FIG. 2 is a schematic drawing of a partially recorded and finalized OTP type dual layer DVD disc,

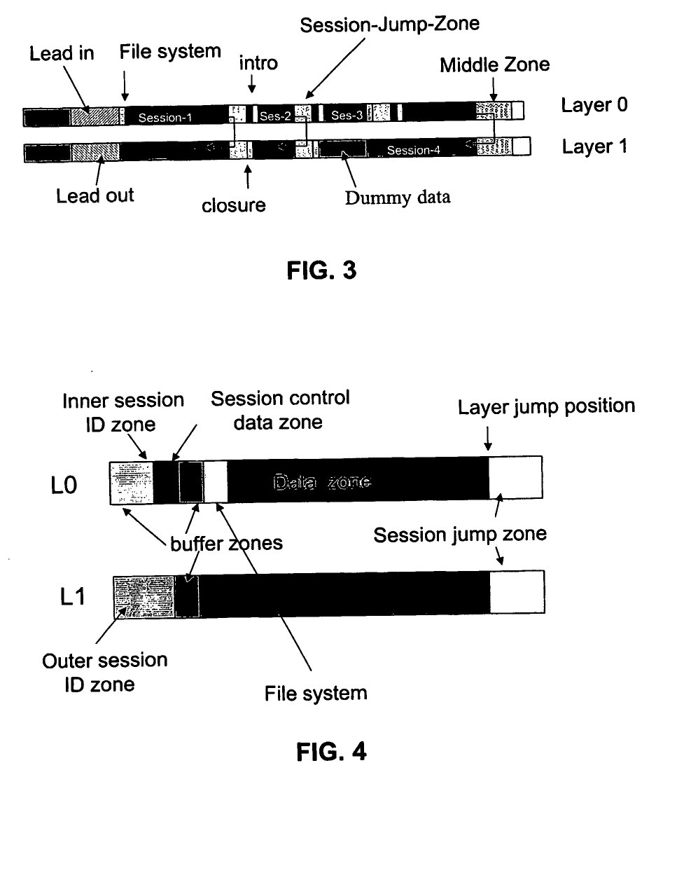

FIG. 3 is a schematic drawing of a finalized OTP type dual layer DVD disc comprising four sessions, where the dummy data region in session-4 is indicated, and

FIG. 4 is a schematic drawing of a super session.

By way of example an embodiment of the invention with a multi-session multi layer DVD+R disc of the OTP type will be discussed. The session format is similar to of DVD+R. Layer jumps in a session are allowed.

The data zone is defined as follows (with reference to FIG. 1): The first Physical Sector Number (PSN) in the data zone on the L0 layer is at address (30000)ₕₑₓ. The middle zone position is fixed, that is, it is placed after the last PSN address of the data zone on the L0 layer, that is at address (22D7DF)ₕₑₓ. The first PSN in the data zone at the L1 layer is at address (DD2820)ₕₑₓ. The last PSN address in the data zone of the L1 layer is at address (FCFFFF)ₕₑₓ. The physical sectors in the intro, closure, and jump zones have specific bits (for example bits 26 and 27) of the data frame set to specified value (for example zero), thereby identifying these zones as if they were data zones.

The multi-session format for multi layer discs allows new sessions to be added, even after the first super session is recorded on the disc. The files in the sessions can be distributed symmetrically over both layers. As a result there are no, or only small, empty spaces, and the disc can be played on most DVD ROM players after session closure (that is, after filling all spaces with dummy data). All sessions can be read in multi-session DVD players and PC drives. Sessions may include zero or more layer jumps.

A finalized dual layer DVD multi session disc according to the invention is shown in FIG. 3. FIG. 3 shows a DVD disc comprising four sessions. The sessions are written in the order of the session numbers. Sessions 1, 2 and 4 each contain a layer jump while session 3 does not (session 3 could, for example, be too small for a layer jump). When a user decides to finalize the disc at this time (after recording the four sessions), a limited finalization time is required (dummy data is to be written to a part of session 4 only) and the capacity of the disc is efficiently used.

Each session has its own intro, (temporary) file system info, data zone, jump zone and closure zone (as is shown in FIG. 4). The size of the jump zone should preferably be sufficiently large. During a layer jump from layer 0 to layer 1 at the end of the data zone of layer 0 there should preferably be data written on layer 1. In an embodiment the jump zone size is fixed to eliminate errors after a layer jump. A preferred jump zone size is approximately 0.2 mm. Such a size ensures that a jump will always arrive at an area comprising information (either user information or dummy data).

Each session contains the file system info of the session itself and of all of the previous sessions. The first session uses the lead-in and lead-out zones for intro and closure. When a session is closed, the file system should preferably be updated. Spaces are to be filled with dummy data.

To enable data retrieval in DVD-ROM drives, the disc should have a lead-in zone, no blank areas in the data zone, a middle zone, and a lead-out zone. When a disc is finalized, all blank areas are filled, the lead-in and lead-out zones are written, and the file system is updated.

To remain compatible with the single layer DVD+R standard, the following measures are introduced according to the invention. The inner-drive zone (see FIG. 2) comprises Optimum Power Calibration (OPC) areas, OPC count zones, administration zones, and a table of contents zone (TOC zone). The TOC zone contains information of the sessions on the disc and a recorded area indicator. A description of the format of a TOC block can be found in the DVD+R standard (on page 48 of version 1.11). In the TOC Error Correction Code (ECC) block there are so-called TOC items of 16 bytes. These TOC items are listed in Table 1 below.

According to the current invention, the following is modified in the TOC block in order to support the super sessions. The last PSN on layer 0 is stored in bytes B13-B15, which were previously not used. In this way the physical address of a super session can be defined without significantly modifying the existing TOC block format.

In every session (in the intro part) there is an inner session identification zone and a session control data zone. A Session Disc Control Block (SDCB) contains important information on the present and previous sessions. The format of the SDCB can be found in the DVD+R standard (on page 64 of version 1.11). The most relevant parts (for the purpose of this invention) of this SDCB are the session items consisting of the fragment item and the previous session item. These are depicted in Table 2 and Table 3 below

Referring to the fragment item depicted in Table 2. The bytes 11 to 13 in a fragment item in the SDCB were not use. In an embodiment of the invention these bytes are used to store the location of the maximum PSN of a session on layer 0. Referring now to the previous session item depicted in Table 3. Again bytes 11 to 13 were not used and in an embodiment of the invention these bytes 11 to 13 are used to specify the maximum PSN of a session on Layer 0.

The two jump zones should be of sufficient size and should preferably contain at least one 1 ECC block. At least one dummy ECC block should be written on the L0 layer and on the L1 layer for run-out, respectively, run-in, preferably immediately before and after a layer jump. After a session closure all open areas should be filled with dummy data, and the most recent file system should be written. Furthermore, the jump zones (such as the middle zone) on the L0 layer and on the L1 layer should be filled, preferably with zero's.

The size of the jump zone should be sufficiently large to guarantee that data is present on the other layer (that is the L1 layer) during a layer jump at the maximum data PSN of the L0 layer.

A schematic drawing of an OTP session with the different blocks is shown in FIG. 4. When a new session is started, an intro and closure zone (for example having a size of 64 ECC blocks) should be written adjacent to the jump zone of the previous session. The procedure for following sessions is similar to that for the first session.

Although the invention is described with reference to a dual layer DVD+R disc of the OTP type, it is noted that the invention is also applicable to other multi layer optical disc formats, including the Parallel Track Path (PTP) format.

TABLE 1
TOC items

| Item Byte | | Number of |
|---|---|---|
| Position | Description | Bytes |
| B0 to B2 | TOC Item Descriptor (“TCI”) | 3 |
| B3 | Session status | 1 |
| B4 | Session number | 1 |
| B5 to B7 | Session start address | 3 |
| B8 to B10 | Session end address | 3 |
| B11 to B12 | Last fragment number in session | 2 |
| B13 to B15 | Prior art: Reserved (00) Present | 3 |
| | invention: last session PSN on L0 | |

TABLE 2
Fragment items

| Item Byte | | Number of |
|---|---|---|
| Position | Description | Bytes |
| B0 to B2 | Fragment Item Descriptor (“FRG”) | 3 |
| B3 to B4 | Fragment number | 2 |
| B5 to B7 | Fragment start address | 3 |
| B8 to B10 | Fragment end address | 3 |
| B11 to B13 | Prior art: Reserved (00) Present | 2 |
| | invention: last session PSN on L0 | |

TABLE 3
Previous session item

| Item Byte | | Number of |
|---|---|---|
| Position | Description | Bytes |
| B0 to B2 | Previous Session item Descriptor (“TCI”) | 3 |
| B3 | Reserved and set to (00) | 1 |
| B4 | Previous Session Number | 1 |
| B5 to B7 | Previous Session Start address | 3 |
| B8 to B10 | Previous Session End address | 3 |
| B11 to B13 | Reserved (00) Present invention: | 3 |
| | last session PSN on L0 | |

1. Method for recording information on a multi layer record carrier, said record carrier comprising at least two information layers for storing the information, wherein the method is adapted for recording the information in multiple sessions.

2. Method according to claim 1, wherein the information of at least one session is distributed over at least two information layers.

3. Method according to claim 2, wherein the information is evenly distributed over the at least two information layers.

4. Device for recording information on a multi layer record carrier, said record carrier comprising at least two information layers for storing the information, wherein the device is operative for recording the information in multiple sessions.

5. Device according to claim 4, wherein the device is operative for performing a layer jump during the recording of information when recording in at least one session.
